(19) United States
(12) Patent Application Publication
(10) Pub. No.: US 2012/0280514 A1
(43) Pub. Date: Nov. 8, 2012

(54) VENTILATION SYSTEMS FOR A WIND TURBINE GENERATOR SYSTEM

(75) Inventors: Thomas Feddern, Hamburg (DE); Holger Klemm, Hamburg (DE)

(73) Assignee: POWERWIND GMBH, Hamburg (DE)

(21) Appl. No.: 13/149,565

(22) Filed: May 31, 2011

(30) Foreign Application Priority Data
May 3, 2011 (DE) 20 2011 100 173.7

(51) Int. Cl. F03D 9/00

(52) U.S. Cl. 290/1 B

(57) ABSTRACT

A ventilation system for a wind turbine generator system having a ventilation duct for conducting a cooling air that has been heated by waste heat from an air intake section of the ventilation duct to an air outlet section of the ventilation duct, along a flow path bounded by a duct wall which extends between the air intake section and the air outlet section, wherein in a sectional plane, preferably in every sectional plane that extends perpendicular to the flow path, the inside span of the ventilation duct can be adjusted by applying pressure to an outer boundary surface of the duct wall.

### CROSS REFERENCE TO RELATED APPLICATIONS

The present application claims international priority under 35 U.S.C. §119 to co-pending German Patent Application No. ______ filed May 3, 2011, the disclosure of which is hereby incorporated by reference in its entirety for all purposes except for those sections, if any, that are inconsistent with this specification.

### TECHNICAL FIELD

The invention relates to a ventilation system for a wind turbine generator system having a ventilation duct for conducting cooling air that has been heated by waste heat from an air intake section of the ventilation duct to an air outlet section of the ventilation duct, along a flow path that is bounded by a duct wall and extends between the air intake section and the air outlet section.

### BACKGROUND

With the generation of electrical power from wind power and the subsequent conversion and transformation of the generated electrical current/electrical voltage in wind turbine energy systems, losses in the form of heat are unavoidably produced. To prevent overheating of the heat-generating components located inside the wind turbine generator system, and to maintain the desired operating temperature thereof, said components are regularly cooled by appropriate apparatus. In particular, the cooling of a generator, in which the mechanical energy of a rotor shaft is converted to electrical energy, but also the cooling of power electronics units, such as transducers, converters or transformers, can be provided, connected between generator and the infeed of the generated current into the power grate.

In wind turbine generator systems, ventilation systems comprising air blowers and/or fans are used for cooling purposes, wherein the cooling air or a cooling gas is forced via ventilation ducts to the units that are to be cooled, where the cooling air takes up waste heat, and is then discharged in its heated state to the outside air via additional ventilation ducts. Closed ventilation systems in which cooling air is circulated are also known.

Frequently, substantial quantities of waste heat are produced in generators of wind turbine generator systems and must be carried off by the cooling air. The power dissipation from waste heat of a generator of a wind turbine generator system is usually more than 1% of the power output of the wind turbine generator system, for example, and therefore within the range of multiple kilowatts. For this reason, bulky and heavy ventilation ducts having a large inside span, and frequently having a diameter of more than 0.5 m, in most cases more than 1 m, are ordinarily provided in the gondola of the wind turbine generator system, for the purpose of supplying the cooling air to the generator and drawing off the heated cooling air. Within this context, the inside span is understood as the cross-sectional area of the ventilation duct that is available for the flow of cooling medium in a direction that extends perpendicular to the flow path.

Because the space available in gondolas of wind turbine generator systems is highly limited anyway, the large amount of space required for these ventilation ducts is particularly problematic. Added to this is the fact that ventilation ducts are ordinarily positioned in the region of the generator or in the region of other electrical systems, so that technicians or maintenance personnel are not able to easily reach said system due to the large amount of space taken up by the ventilation ducts. Moreover, escape routes and/or passageways in wind turbine generator systems are frequently narrowed by the ventilation ducts, and cabinet doors or other containers can be opened to only a limited extent while the wind turbine generator system is operating because of the ventilation ducts. Conventional ventilation ducts are ordinarily made of metal pipes or plastic pipes, or rigid bellows having reinforcement frames, and are therefore awkward to handle, and can be transported and mounted only at great expense.

### BRIEF DESCRIPTION OF THE DRAWINGS

Embodiments of the invention are explained below with reference to the drawings, to which reference is made with respect to all details that are material to the embodiments.

FIG. 1 shows the ventilation duct of a ventilation system according to the invention from a perspective view.

FIG. 2 shows the ventilation duct of FIG. 1, installed in the gondola of a wind turbine generator system, from a side view.

FIG. 3 shows the air outlet section of the ventilation duct of FIG. 1 and the discharge area connected thereto, from a side view.

FIG. 4a shows a schematic side view of the interior of the gondola of a wind turbine generator system having the ventilation system according to the invention, with the ventilation duct in the operational mode.

FIG. 4b shows a schematic side view of the interior of the gondola of FIG. 4a, after the ventilation duct has been shifted to the maintenance mode.

FIG. 5 shows a schematic view of the interior of the gondola of FIG. 4a from the rear.

### DETAILED DESCRIPTION OF EMBODIMENTS OF THE INVENTION

In view of the described problems, the problem addressed by the invention is that of providing a ventilation system for a wind turbine generator system, which will enable improved handling, and with which the space available in the gondola of a wind turbine generator system can be optimally utilized.

This problem is solved by a further development of a ventilation system known in the prior art, which is characterized essentially in that the inside span of the ventilation duct can be adjusted within a sectional plane, particularly in every sectional plane that extends perpendicular to the flow path, by applying pressure to an outer boundary surface of the duct wall.

In other words, the duct wall is flexible and yields to the application of pressure, or can be pressed inward in the direction of the flow path by applying pressure.

It is provided according to the invention that the inside span of the ventilation duct can be adjusted at least in a center duct section lying between the air intake section and the air outlet section, by applying pressure to the outer boundary surface of the duct wall, wherein the length of said center duct section in the direction of the flow path preferably corresponds to more than 40%, particularly preferably more than 60%, particularly more than 80% of the length of the ventilation duct. As described above, in one particularly preferred embodiment, the entire duct wall is flexible, and therefore the inside span can be adjusted in every sectional plane extending perpendicular to the flow path by applying pressure from the outside.

On the other hand, the inside span of the ventilation duct can also preferably be adjusted according to the invention by applying pressure from the inside to the interior boundary surface of the duct wall, so that during operation of the ventilation system, the duct wall is forced outward by the pressure of the cooling air flowing through the duct. As a result of this, when the ventilation system is in operation, the inside span of the duct can be greater, due to the cooling medium flowing through the ventilation duct, than when the ventilation system is switched off. While the ventilation system is in operation, when pressure applied from the outside, for example, by a member of maintenance staff or by an opening cabinet door, is greater than the pressure applied from the inside by the cooling air, the duct wall will yield and will be pressed inward.

The inside span in a sectional plane, particularly in every sectional plane that extends perpendicular to the flow path, is preferably greater than 0.5 m², preferably greater than 1 m², particularly 1.5 m² or more. With a large inside span of the ventilation duct, more cooling air can flow through the ventilation duct per unit of time, thereby improving the cooling effect. The flow path of the ventilation duct preferably has a total volume of several cubic meters, to allow it to carry off the necessary quantity of cooling air.

The duct wall is expediently embodied in the form of a flexible film made at least partially of plastic. In contrast to materials that are traditionally used to produce the duct wall, such as sheet metal or plastic plates or frames, a film is particularly lightweight and can be embodied as particularly flexible. It nestles flexibly in an optimal manner against the pipes or cable already present in the interior of the gondola, so that the available space can be utilized particularly well, without requiring special measures for adapting the ventilation duct to the dimensions of the generator or gondola environs. Moreover, a film will yield particularly readily under pressure, so that the ventilation duct will expand to its maximum inside span as a result of the cooling air flowing through it, but at the same time, a technician or maintenance staff member can get past by the ventilation duct under narrowed space conditions by pressing the duct wall inward, thereby creating additional passageways.

A multilayer composite film having a first layer that forms the outer boundary surface and a temperature resistant second layer, which is also preferably spark resistant, has proven particularly suitable for producing the duct wall. A temperature resistant inner layer is able to withstand high temperature cooling air. In contrast, the outer layer can be chosen on the basis of cost, weight, and/or stability and flexibility criteria. The layer that forms the outer boundary layer should also be suitable for the stitching or welding of film parts to produce the ventilation duct.

It has been found that a first layer made of PVC and/or a second layer made of silicone provide these required properties particularly well. Silicone is particularly temperature- and spark-resistant. PVC is particularly cost-effective to produce, and can be made as flexible as necessary while remaining stable and resistant to tearing by adding corresponding softeners and/or stabilizers. The composite film that forms the duct wall can be produced by surface welding the outer layer made of PVC to the inner layer made of silicone.

The duct wall expediently consists of a plurality of film sections attached to one another, particularly stitched and/or welded to one another. For example, a total of four flat lateral surfaces for forming the four side walls of the duct wall can be cut from a film and then stitched to one another at overlapping edges to form the ventilation duct, such that they enclose the cooling air with a tight seam. This method produces a particularly lightweight and therefore easily transportable and easily installable ventilation duct.

The duct wall is expediently embodied as a single piece. In other words, the entire section of the ventilation duct between air intake and air outlet sections consists of a single component, which can be dismantled into a plurality of fragments only if destroyed. For example, a plurality of film pieces stitched or welded to one another form a single component of this type. A single-piece duct wall offers advantages with respect to weight, transportability and ease of handling.

The ventilation duct can expediently be shifted from an operational mode to a maintenance mode, wherein the total volume of the ventilation air duct in the operational mode is preferably more than 2 times, particularly preferably more than 5 times, expediently more than 10 times, particularly more than 30 times as large as in the maintenance mode.

In a first embodiment provided according to the invention, a ventilation duct having a duct wall embodied in the form of a film is shifted to the maintenance mode by folding it together, in which the connection of the ventilation duct to the gondola on at least one side of the ventilation duct is detached, and the film-type flexible duct wall is then folded together. In this case, the air intake section is placed directly on the air entrance section, and the duct wall located between these is collapsed in a folded manner. It has been found that in this embodiment, the total volume of the ventilation duct is more than 30 times as large in the operational mode as in the maintenance mode. The ventilation duct is folded together, for example, for the purpose of disassembly or for maintenance of an electrical unit and/or for creating an escape route, or for opening a cabinet door that is blocked by the ventilation duct in its operational mode.

In an alternative, particularly preferred embodiment, the ventilation duct is shifted from the operational mode to the maintenance mode by pivoting a reinforcement frame that is mounted in the air intake section or in the air outlet section, for example, by “folding it up.” The folded up reinforcement frame can then be fastened to a holding element, such as a hook, provided in the gondola, and maintenance personnel can then reach areas in the interior of the gondola that are occupied by the ventilation duct in the operational mode thereof. In particular, cabinet doors which are blocked by the ventilation duct in the operational mode can be opened.

A grate or some similar element, which extends transversely to the flow path, is preferably provided in the region of the air intake section and/or the air outlet section. In the operational mode, the cooling air is able to flow through the grate, and in the maintenance mode, when the ventilation duct is folded together or folded up, said grate is passable by maintenance personnel. Thus the existing interior gondola space can be optimally utilized for maintenance purposes.

The average weight per unit area of the duct wall is expediently less than 2 kg/m², preferably less than 1.3 k g/m², particularly 0.9 kg/m² or less. A lightweight ventilation duct offers advantages with respect to handling, transport and installation. A plastic film made of silicone and/or PVC in the aforementioned weight range has proven sufficiently stable and resistant.

The entire ventilation duct can be transported and installed by only a single person if the total weight of the exhaust air duct is less than 50 kg, preferably less than 30 kg, particularly preferably less than 20, particularly approximately 15 kg or less. If a film is used to produce the duct wall, this weight can also be achieved in ventilation ducts that have a total volume of one or more cubic meters.

In one preferred embodiment according to the invention, the air intake section of the ventilation duct can be detachably coupled to a connecting flange on the intake side by means of a first fastening means, and the air outlet section of the ventilation duct can be detachably coupled to a discharge area for carrying off the heated cooling air, by means of a second fastening means. The discharge area can have an additional ventilation duct for conducting the cooling air, or can alternatively conduct it directly to the outside air. The connecting flange on the intake side can be part of an additional ventilation duct, the generator, another electrical unit or a fan. The detachable coupling of air intake and/or air outlet section to the gondola ensures the detachability of the ventilation duct or the shiftability thereof to the maintenance mode.

In the interest of a simple coupling and/or a simple detachment of the ventilation duct to/from the gondola, it has proven particularly advantageous for the first and/or the second fastening means to comprise a Velcro closure. A Velcro closure allows an air-tight connection to be produced, which can be particularly rapidly coupled and uncoupled. The hooks of the Velcro closure are positioned, for example, on an edge of the ventilation duct that faces the connecting flange, in the air intake section, whereas the loops of the Velcro closure are placed in a complementary position on the connecting flange, or vice versa.

Alternatively or additionally, the second and/or the first fastening means can have one or more clamping and/or screw-type elements for connecting a reinforcement frame, provided on the ventilation duct, to the discharge area or the connecting flange. The clamping elements are, for example, clamping plates or hinges. The screw-type elements are, for example, screws with star knobs, so that connection and detachment can be accomplished without the use of a tool. The connection by means of screw-type elements is particularly reliable and at the same time air-tight, whereas it can be easily and rapidly detached due to the star knobs.

In a particularly preferred embodiment, a reinforcement frame is provided in the air outlet section. A first edge region of the reinforcement frame is held in place by holding or clamping plates, which overlap the first edge region, and a second edge region of the reinforcement frame, which is opposite the first edge region, is connected to the discharge area by means of screws. It has been found that three screws are sufficient to produce an air-tight and adequately stable connection between the ventilation duct and the discharge area.

To enable a rapid and practical shifting of the ventilation duct from the operational mode to the maintenance mode and vice versa, the connection of the air intake section to the connecting flange and/or the connection of the air outlet section to the discharge area can be detached without the use of a tool. For this reason, Velcro closures and/or screw-type elements having star knobs are preferably used as connecting elements according to the invention, wherein 5 or fewer screw-type elements are sufficient for the connection.

The ventilation duct is expediently angular, preferably quadrangular, particularly preferably rectangular, in a sectional plane, particularly in every sectional plane that extends perpendicular to the flow path. The available space in the interior of the gondola can thereby be utilized particularly efficiently.

The flow path preferably has at least one curved section. A ventilation duct that is curved at least in sections can be used more flexibly than a straight ventilation duct. For instance, the heated cooling air guided in the horizontal direction out of the generator can be discharged toward the bottom or toward the top to the outside air, with a minimal requirement of space. The ventilation duct preferably has one section having a substantially straight flow path and one curved section, in which the direction of the flow path changes by approximately 90°.

In order for the ventilation duct to have at least essentially the inside span that is necessary in the operational mode, even without internal pressure, despite the curved section, it can be secured by tensioning elements such as tensioning cables and/or rubber bands. The ventilation duct is further stabilized and held in position by the tensioning elements.

Each of the tensioning elements can be attached at one side to the duct wall in the region of the curved section, and at the other side to a supporting section of the wind turbine generator system. The ventilation duct is thereby optimally stabilized and the curved section optimally shaped.

Two tensioning elements that can be attached to the duct wall on the outer side of the curve ensure, according to the invention, a sufficient stabilization of the ventilation duct, while at the same time, a simple and rapid installation and detachment or shifting from the operational mode to the maintenance mode is possible by detaching only two tensioning elements. Due to the flexibility and the light weight of the duct wall, no more than two tensioning elements are required.

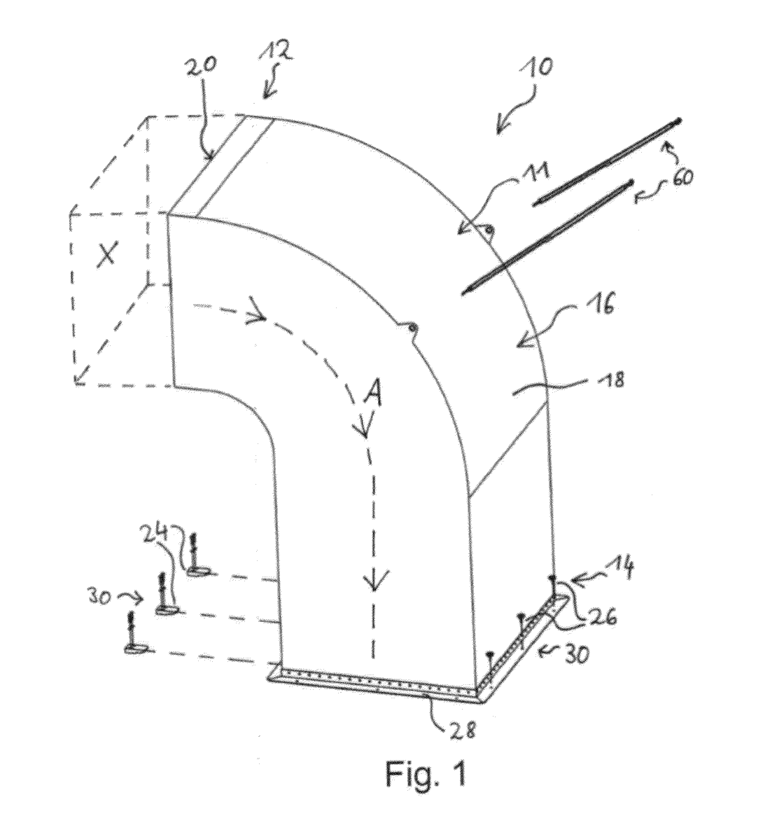

FIG. 1 shows a ventilation duct 10 of a ventilation system according to the invention, for a wind turbine generator system. The ventilation duct 10 serves to conduct cooling air that has been heated by waste heat. The waste heat is produced, for example, in a generator 70, as a result of the conversion of mechanical energy to electrical energy. The cooling air is conducted through the ventilation duct 10, along a flow path A that is bounded by a duct wall 16 of the ventilation duct 10, and then reaches a discharge area 22, which discharges the cooling air into the outside air.

At the end of the ventilation duct 10 that faces the generator, said duct has an air intake section 12, via which the ventilation duct 10 is connected to a connecting flange 50 of the generator 70, and at the end of the ventilation duct 10 that faces the discharge area, said duct has an air outlet section 14, via which the ventilation duct 10 is connected to the discharge area 22. Each of the connections is embodied as air-tight.

The duct wall 16 extends between the air intake section 12 and the air outlet section 14, and forms an edge around the flow path A. When pressure is applied to the duct wall 16, it yields at its outer boundary surface 18, and can be pressed inward. In other words, the inside span X of the ventilation duct 10 can be adjusted by applying pressure to the outer boundary surface 18 of the duct wall 16.

This adjustability of the inside span X by applying pressure is ensured in the embodiment illustrated in the figures in that the duct wall 16 consists of a flexible film. The film comprises two layers, with an inner layer made of silicone and an outer layer made of PVC. Other film combinations or the fabrication of the duct wall using other flexible materials are also conceivable.

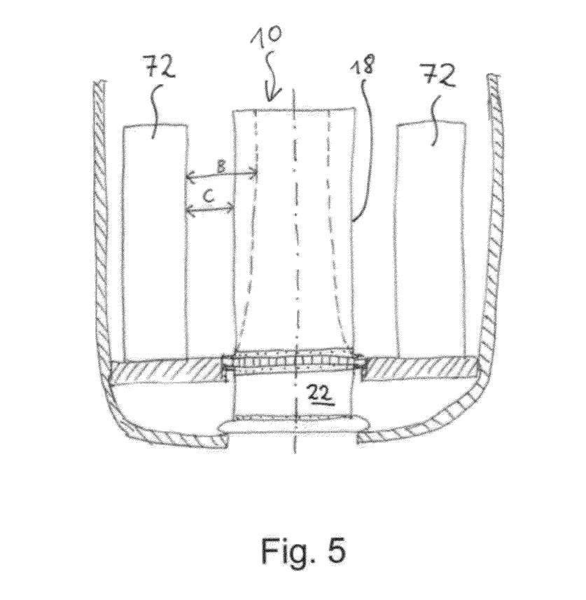

As is particularly clear from FIG. 5, passageways inside gondolas of wind turbine generator systems are frequently narrow. Added to this is the fact that doors of cabinets 72 or other containers cannot be opened in the operational mode with conventional ventilation systems, because said doors are blocked by a ventilation duct. In contrast, the ventilation duct 10 of the ventilation system according to the invention can be pressed inward from the position C to the position B (see FIG. 5) by applying pressure to the outside of the duct wall 16, wherein in the position C, maintenance personnel are able to pass through the passageway between cabinet 72 and ventilation duct 10.

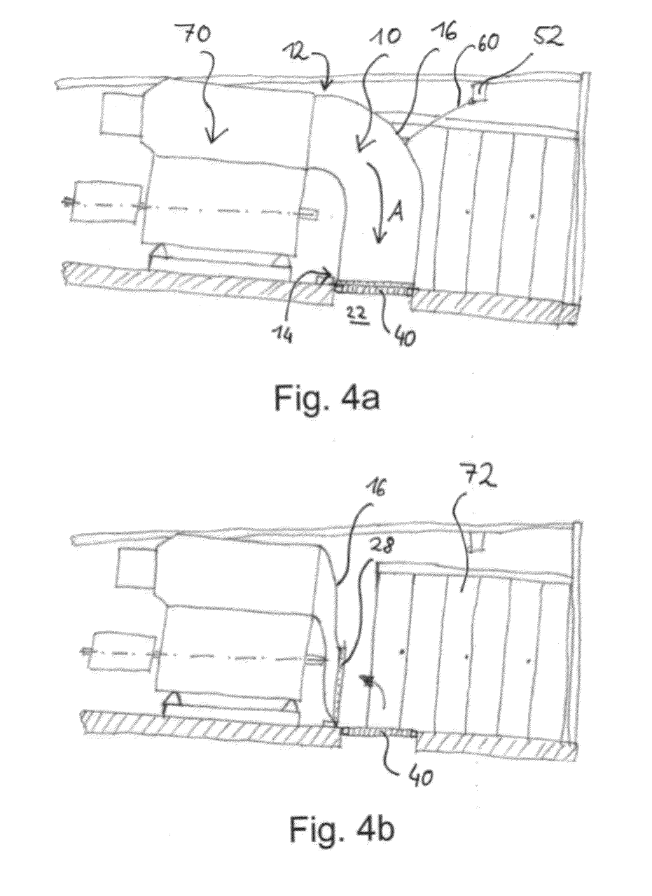

As is particularly clearly illustrated in FIG. 4, the ventilation duct 10 of the ventilation system according to the invention can be shifted from an operational mode (FIG. 4a) to a maintenance mode (FIG. 4b) by pivoting a reinforcement frame 28, which is located in the air outlet section 14, upward. In this manner, the total volume of the ventilation duct 10 is reduced to less than half. In the maintenance mode (FIG. 4b), the doors of the cabinets 72 are not blocked by the ventilation duct 10 and can be easily opened. Between discharge area 22 and ventilation duct 10, a grate 40 is positioned, extending transversely to the flow path A, wherein in the operational mode, cooling air flows through said grate, and in the maintenance mode, a person is able to walk on the grate.

The inside span X of the ventilation duct has an area of approximately 1.5 m², and in the operational mode, the ventilation duct has a total volume of several cubic meters. Nevertheless, because the duct wall 16 is constructed of a flexible film, the ventilation duct 10 has a weight of fewer than 50 kg and can be transported by a single person. However, other dimensions for the ventilation duct are also conceivable according to the invention. In particular, the required inside span of the ventilation duct is ordinarily dependent on the size of the wind turbine generator system and the electrical power it generates.

The ventilation duct 10 has an approximately square cross-section. The flow path has a curved section 11, in which the flow path A, which exits the generator 70 in a horizontal direction, curves down, and then runs approximately linearly downward. Another shape of the flow path A or another shape of the ventilation duct A are also conceivable according to the invention. On the side of the duct wall 16 on the outside of the curve, two rubber bands or cables are located as tensioning elements 60 for securing the curved section 11. Each of the tensioning elements 60 is attached at one end to the duct wall 16 and at the other end to a supporting section 52 of the gondola. The tensioning elements 60 shape the duct wall in the region of the curved section 11 and hold said wall in position. To shift the ventilation duct from the operational mode to the maintenance mode, the two tensioning elements 60 are detached from the duct wall 16. For this purpose, at the front end of each tensioning element 60, for example, a hook can be provided, and on the duct wall 16 in each case, an eye, or the like, can be provided for attaching said hook.

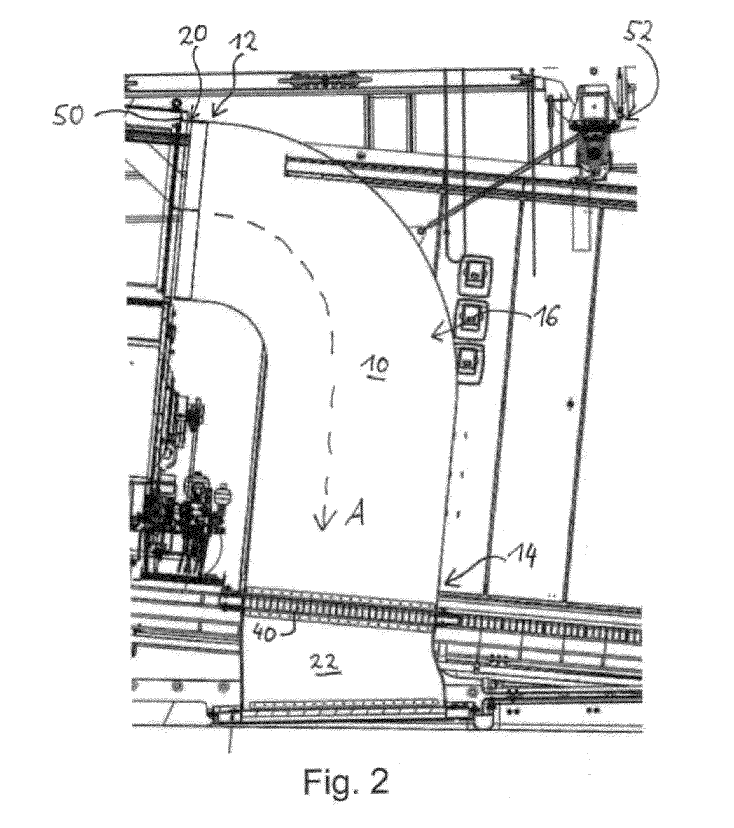

FIG. 2 shows the ventilation duct 10 installed in the gondola, from a side view. The air intake section 12 is detachably coupled to the connecting flange 50 on the intake side by means of a first fastening means 20. The fastening means 20 is a Velcro closure, which is positioned all the way around the intake opening of the ventilation duct and all the way around the connecting flange, and thereby ensures an air-tight connection.

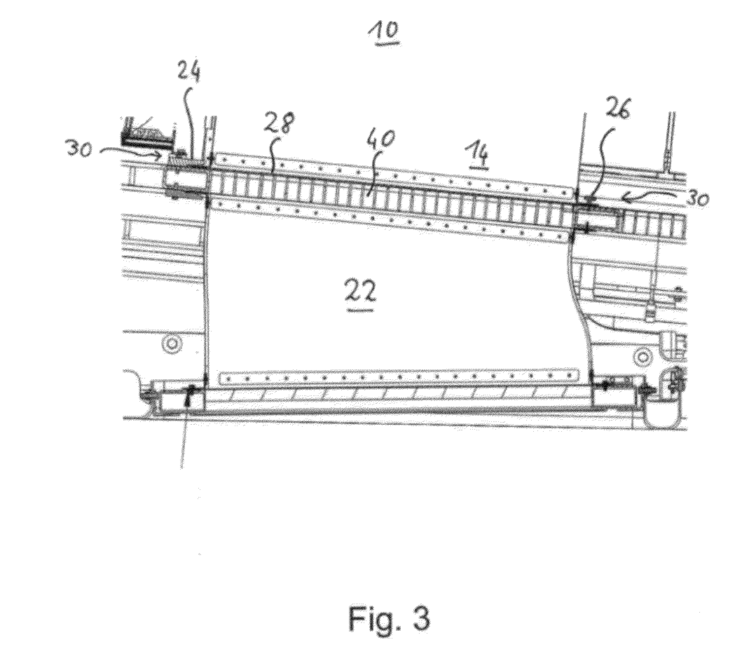

As is shown particularly clearly in FIG. 3, the air outlet section 14 is detachably coupled to the discharge area 22 by means of a second fastening means 30. The second fastening means 30 has a plurality of clamping elements 24 and a plurality of screws 26, which serve to connect the reinforcement frame 28 located in the air outlet section 14 to the discharge area 22. A first edge of the reinforcement frame 28 is overlapped by the clamping elements 24, and a second edge of the reinforcement frame 28 is attached by means of the screws 26 to a mounting surface in the discharge area 22. The screws 26 have star knobs, or the like, so that said screws can be tightened and loosened without the use of a tool.

In the embodiment shown in the figures, in order to shift the ventilation duct to the maintenance mode, first the two tensioning elements 60 and then a total of three screws must be detached. The reinforcement frame can then be pivoted upward into the maintenance mode.

A ventilation system according to the invention is not limited to the described embodiment. Rather, it is obvious to a person skilled in the art that ventilation ducts of other shapes and/or made of different materials, or ventilation ducts having other dimensions can also have the features specified in claim 1. Moreover, alternative shifting possibilities for shifting the ventilation duct to the maintenance mode are also conceivable.

1. A ventilation system for a wind turbine generator system comprising:
a ventilation duct for conducting a cooling air that has been heated by waste heat from an air intake section of the ventilation duct to an air outlet section of the ventilation duct, along a flow path that is bounded by a duct wall and extends between the air intake section and the air outlet section, wherein in a sectional plane extending perpendicular to the flow path, an inside span of the ventilation duct can be adjusted by applying pressure to an outer boundary surface of the duct wall.

2. The ventilation system of claim 1, wherein in the sectional plane, the inside span is greater than 0.5 m².

3. The ventilation system of claim 1, wherein the duct wall is embodied in the form of a flexible film comprising, at least in part, plastic.

4. The ventilation system of claim 3, wherein the film is a multilayer composite film having a first layer that forms the outer boundary surface and a temperature-resistant second layer.

5. The ventilation system of claim 4, wherein the first layer comprises PVC and the second layer comprises silicone.

6. The ventilation system of claim 3, wherein the duct wall comprises a plurality of film parts connected to one another.

7. The ventilation system of claim 1, wherein the duct wall comprises a single piece.

8. The ventilation system of claim 1, wherein the ventilation duct is configured to be shifted from an operational mode to a maintenance mode, wherein the total volume of the ventilation duct in the operational mode is more than 2 times greater than the total volume of the ventilation duct in the maintenance mode.

9. The ventilation system of claim 8, further comprising a grate located in a region of the air intake section or the air outlet section, or both, and extending transversely to the flow path, wherein in the operational mode, cooling air can flow through said grate, and in the maintenance mode, a maintenance staff member can walk on the grate.

10. The ventilation system of claim 1, wherein the mean weight per unit area of the duct wall is less than 2 kg/m².

11. The ventilation system of claim 1, wherein the total weight of the ventilation duct is less than 50 kg.

12. The ventilation system of claim 1, wherein the air intake section is configured to be detachably coupled to a connecting flange on the intake side by a first fastener, and the air outlet section is configured to be detachably coupled to a discharge area for discharging the heated cooling air, by a second fastener.

13. The ventilation system of claim 12, wherein the first fastener or the second fastener, or both, comprises a Velcro closure.

14. The ventilation system of claim 12, wherein the first fastener or the second fastener, or both, comprises one or more clamping elements or screw-type elements, or both, configured to connect a reinforcement frame provided on the ventilation duct, to the connecting flange, or the discharge area.

15. The ventilation system of claim 12, wherein the air intake section and the connecting flange are configured to be manually detached, and wherein the air outlet section and the discharge area are configured to be manually detached.

16. The ventilation system of claim 1, wherein the ventilation duct, in a sectional plane that extends perpendicular to the flow path, is angular.

17. The ventilation system of claim 1, wherein the flow path has at least one curved section.

18. The ventilation system of claim 17, further comprising tensioning elements configured to secure the curved section of the ventilation duct to maintain the inside span.

19. The ventilation system of claim 18, wherein the tensioning elements are connected at one end to the duct wall in the region of the curved section and at the other end to a supporting section of the wind turbine generator system.

20. The ventilation system of claim 18, wherein the tensioning elements comprising precisely two tensioning elements that can be fastened to the duct wall on the outer side of the curve.
